(19) United States
(12) Patent Application Publication
(10) Pub. No.: US 2019/0345341 A1
(43) Pub. Date: Nov. 14, 2019

(54) ANTI-DAZZLING UV CURABLE COATING COMPOSITION, METHOD OF APPLYING THE SAME AND SUBSTRATE COATED THEREWITH

(71) Applicant: PPG Coatings (Tianjin) Co., Ltd., Tianjin (CN)

(72) Inventors: Wenfu Yang, Kunshan (CN); Zhengsong Luo, Suzhou (CN); Haifeng Liu, Suzhou (CN)

(73) Assignee: PPG Coatings (Tianjin) Co., Ltd., Tianjin (CN)

(21) Appl. No.: 16/474,811

(22) PCT Filed: Dec. 27, 2017
(86) PCT No.: PCT/CN2017/119033

§ 371 Date: Jun. 28, 2019

(30) Foreign Application Priority Data
Dec. 30, 2016 (CN) 201611256121.8

(51) Int. Cl. C09D 4/06; B05D 7/24; B05D 7/04; B05D 3/06; C08F 220/28

(52) U.S. Cl. CPC C09D 4/06; B05D 7/24; B05D 7/04; B05D 3/067; C08F 2220/343; B05D 2201/02; B05D 2502/00; B05D 2503/00; B05D 2602/00; C08F 220/28

(57) ABSTRACT

Provided is an anti-dazzling UV curable coating composition comprising a high-functionality polyurethane acrylate oligomer and an active monomer. Further provided are a method for coating a substrate with the anti-dazzling UV curable coating composition and the substrate coated therewith.

### FIELD OF INVENTION

The present invention relates to an anti-dazzling UV curable coating composition and in particular to an UV curable coating composition comprising a high-functionality UV curable polyurethane acrylate oligomer and a polyfunctional active monomer. The present invention further relates to a method of coating a substrate with the UV curable coating composition and the substrate coated therewith.

### BACKGROUND OF THE INVENTION

Anti-dazzling coats are mainly useful for a display on board, a PET protective film of mobile phones and a display for computers. “Glaring” is a bad illumination phenomenon, which occurs when a light source has extremely high brightness or brightness difference between the background and the center of the field is considerable. When one sees the “glaring”, he/she will has a feeling of dazzling and may faint, be uncomfortable and even have a film over the eyes. Furthermore, the “glaring” phenomenon will not only badly affect effect of viewing and but also be harmful to the eyesight health. An anti-dazzling coat is capable of effectively reducing such effect and would make it clear even in the light or sunshine.

Current anti-dazzling coats exhibit poor abrasion resistance, mainly reflected by significant difference in contact angle before and after steel wool testing. Therefore, there is a need in the art for an anti-dazzling coat which has high abrasion resistance and is suitable for a curtain coating and roll coating process.

### SUMMARY OF THE INVENTION

The present invention provides UV curable coating composition, comprising an UV curable polyurethane acrylate oligomer having functionality greater than or equal to 6 and an active monomer.

The present invention further provides a method of forming a coating on a substrate, comprising applying an UV curable coating composition to at least a portion of the substrate, wherein the UV curable coating composition comprises an UV curable polyurethane acrylate oligomer having functionality greater than or equal to 6 and an active monomer.

The present invention further provides a coated substrate, comprising a substrate and an UV curable coating composition deposited on at least a portion of the substrate, wherein the UV curable coating composition comprises an UV curable polyurethane acrylate oligomer having functionality greater than or equal to 6 and an active monomer.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims, are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in the description and appended claim, the articles “a”, “an”, and “the” include plural references, unless specifically stated as one reference.

The present invention is directed to provide an abrasion-resistant and anti-dazzling coating composition, which is UV curable. UV curing has advantages such as short curing time, simple equipment, high energy utilization and no harm to environment, and therefore it is widely used for rapid curing of coatings, prints, crosslinking agents, and structural materials. UV curing is especially suitable for surface coats of electronic consumer products.

The UV curable coating composition according to the present invention comprises a high-functionality UV curable polyurethane acrylate oligomer and a polyfunctional active monomer.

The polyurethane acrylate oligomer is typically prepared by reacting polyisocyanate, polyol, and acrylic hydroxyl ester. As the polyurethane acrylate oligomer contains urethane and acrylate functional groups, the coat formed upon curing will possess high scratch resistance, flexibility, high tear strength and low temperature property contributed by polyurethane and excellent optic properties and weather resistance contributed by polyacrylate. The polyurethane acrylate oligomer that can be used in the present invention may be an aliphatic polyurethane acrylate oligomer and an aromatic polyurethane acrylate oligomer. The aliphatic polyurethane acrylate oligomer is preferred because it has superior flexibility and light stability, and is not prone to yellowing.

The aliphatic polyurethane acrylate oligomer that can be used in the present invention preferably has functionality greater than or equal to 6. Such high-functionality polyurethane acrylate exhibits high reaction activity, and has excellent abrasion resistance, stain resistance, and chemical resistance, and also can meet the requirement on the contact angle after steel wool testing. Preferably, the polyurethane acrylate oligomer having functionality greater than or equal to 6 that can be used in the present invention preferably has a number average molecular weight (Mn) of 700-2500 and a viscosity of 1000-2000 cps at room temperature. The number average molecular weight (Mn) is determined by gel permeation chromatography using an appropriate standard such as a polystyrene standard.

The polyurethane acrylate oligomer may be present in the coating composition in an amount of 20-60 wt % based on the weight of the coating composition.

Many commercially aliphatic polyurethane acrylate oligomer can be used in the present invention. For example, examples of such aliphatic polyurethane acrylate that can be used in the present invention include, but are not limited to, DRU-188C from Changxing Chemical, 906S from Negami, UA-830 from Jesida, and the like.

The active monomer used in the present invention is preferably a polyfunctional UV curing monomer. As used therein, the “polyfunctional monomer” refers to one which contains three or more active groups capable of participating in a photocuring reaction per molecule. As a result, the photocuring rate is fast with high crosslinking density. The resulting cured film has thus high hardness and excellent abrasion resistance. Moreover, the polyfunctional monomer can adjust some properties of the film as needed, for example, facilitating the curing speed, and improving hardness and scratch resistance.

The polyfunctional active monomers that can be used in the present invention include, but are not limited to, trimethylolpropane triacrylate, trimethylolpropane trimethacrylate, trimethylolpropane ethoxylate triacrylate, pentaerythritol triacrylate, tri(proxy) glycerol triacrylate, tris (2-hydroxy ethyl) isocyanurate triacrylate, di(trimethylolpropane) tetraacrylate, pentaerythritol tetraacrylate, tetra(ethoxy) pentaerythritol tetraacrylate, and dipentaerythritol hexaacrylate. Preferably, the active monomer comprises pentaerythritol tetraacrylate, tetra(ethoxy) pentaerythritol tetraacrylate, and dipentaerythritol hexaacrylate.

The active monomer may be present in an amount of 5-25 wt % based on the weight of the UV curable coating composition.

Many commercially available active monomers can be used in the present invention. For example, examples of such active monomers that can be used in the present invention include, but are not limited to, LuCure® 865, Unymer M519, Sartomer 399, ETERMER 265, and any combination thereof.

Use of the high-functionality polyurethane acrylate oligomer and the polyfunctional active monomer in combination can increase the curing speed, enhance the mechanical property of the coat film, and improve wet dispersion to additives.

The UV curable coating composition according to the present invention further comprises a photoinitiator. There is no particular limitation to the photoinitiator used, as long as it can decompose to generate free radicals upon exposure to light radiation and initiate a photopolymerization reaction. Available photoinitiators include, but are not limited to benzoin derivative, benzil ketal derivateice, dialkoxy acetophenone, α-hydroxyalkylphenylketone, α-aminealkylphenylketone, acyl phosphine hydride, esterified oxime ketone compounds, aryl peroxide ester compounds, halo methyl aryl ketone, organic sulphur-containing compounds, benzoylformate, and the like. Two or more photoinitiators may be selected as needed. The photoinitiator may comprise 0.5-6 wt % based on the UV curable coating composition.

Many commercially available photoinitiators can be used in the present invention. For example, examples of such photoinitiators that can be used in the present invention include, but are not limited to, DBC184/BP from Taiwan DBC, 184/BP/MBF from Ciba, and any combination thereof.

The UV curable coating composition according to the present invention further comprises an organic solvent. There is no specific limitation to the solvent used, which can be any of organic solvents known by those skilled in the art and which includes, without limitation, an aliphatic or aromatic hydrocarbon such as Solvesso 100™, toluene or xylene, an alcohol such as butanol or isopropanol, an ester such as ethyl acetate, butyl acetate or iso-butyl acetate, a ketone such as acetone, methyl isobutyl ketone or methyl ethyl ketone, an ether, an ether-alcohol or an ether ester such as ethyl 3-ethoxypropionate, or a mixture of any of the aforesaid. Preferably it is ethyl acetate and/or iso-butyl acetate. The solvent is usually in an amount of 10-50 wt % of the UV curable coating composition.

The UV curable coating composition according to the present invention further comprises one or more other additives, which include, but are not limited to a dispersant, a leveling agent, a matting agent, an antioxidant, a deforming agent, a rheological agent, and the like. The types of these additives are well-known by those skilled in the art and the amount thereof will be easily determined by those skilled in the art as needed.

The UV curable coating composition according to the present invention may be applied onto at least a portion of the substrate by known techniques in the art, which for example comprise spraying, rolling, curtain coating, dipping/immersion, brushing, or flow coating. Then, the resulting coating film is subjected to a UV curing, which may for example be achieved by pre-baking with IR hot wind for 5-10 min followed by a UV curing. The UV curing may be conducted for example under conditions including baking at 50-80° C. for 5-10 min to evaporate the solvent, followed by UV irradiating at UV energy of 400-1600 mJ/cm² and light intensity of 80-300 mW/cm². The film thickness of the coating is usually in the range of 3 to 10 μm.

The UV curable coating composition according to the present invention may be applied to any substrate. Said substrate may include, but are not limited to ceramics, woods, leathers, stones, glass, alloy, paper, plastics, fiber, cotton textiles, and the like, preferably plastic substrates. The plastic substrates particularly refer to an electronic display of an electronic product, such as a display on board, a PET protective film of a mobile phone and a display of a computer. The plastic substrate may be prepared from polymethyl methacrylates (PMMA), polycarbonates (PC), and polyethylene terephthalate (PET).

### EXAMPLES

The following examples are provided to illustrate the invention, which, however, are not to be considered as limiting the invention to their details. Unless otherwise indicated, all parts and percentages in the following examples, as well as throughout the specification, are by weight.

### Preparation Examples

The UV curable coating composition according to the present invention was prepared by mixing the components and amounts thereof listed in Table 1.

TABLE 1
Formulation of UV curable coating composition

| | Example 1 | Example 2 | Example 3 |
|---|---|---|---|
| | (wt %) | (wt %) | (wt %) |
| Polyurethane acrylate oligomer ¹ | 35 | 45 | 60 |
| Active monomer² | 15 | 5 | 5 |
| Solvent³ | 37.5 | 37.5 | 22.5 |
| Photoinitiator⁴ | 2.5 | 2.5 | 2.5 |
| Dispersant⁵ | 1.0 | 1.0 | 1.0 |
| Matting agent⁶ | 9 | 9 | 9 |
| Total | 100 | 10 | 100 |

¹ Jesida UA-895
²Sartmoer SR399
³Isobutyl acetate
⁴Irgacure 184
⁵BYK-2163
⁶Evonik AMORPHOUS SILICA TT-600.

Preparation Process of Coats

The coating compositions were diluted with a diluent formulated by mixing ethyl acetate, n-butanol, propanol in an appropriate ratio, such that the coating compositions after dilution have a viscosity of 7.5-8.5 s where the viscosity was measure through an IWATA 2# CUP. Then, the diluted coating compositions were coated onto the PMMA/PC/PET substrate via any of spraying, curtain coating, rolling, dipping/immersion coating followed by baking at 50-80° C. for 5-10 min to remove the solvent. The photoinitiator decomposed to generate active free radicals via exposure to UV light radiation (UV energy: 400-1600 mJ/cm², light intensity: 80-300 mw/cm²) and initiated a polymerization between the monomer and the resin, forming a film of three-dimensional crosslinked network to obtain the basecoat.

Then, the substrates coated with the UV curable coating composition of the present invention were tested for the following properties. Results were shown in Table 2.

Testing Items

1. Pencil Hardness

Requirement on Pencil:

Mitsubishi 4H pencil and 1000# sandpaper were chosen. Pencil point is at an angle of 90° with the plane of the sandpaper, and then it was worn into a cylindrical shape.

Testing Method.

The pencil was mounted on a pencil hardness tester, calibrated, adjusted into balance, and loaded with a weight of 1 kg. Three lines having a 5-10 mm length were cut at an angle of 45±1 in different positions of the fingerprint sensing surface of the sensor. Then, pencil scratches were erased with an eraser.

Note: rotating the pencil 90 degrees after scratching once to avoid the abrasion area of the pencil point, otherwise, testing results were invalid.

2. Adhesion of Cured Film

The sample surface was cut by 6×6 lines with a NT knife (1 mm² gird (lattice), total number of 25; the marking penetrating all the way to the substrate) and the testing surface remained as even as possible (keeping the blade sharp). If the sample was too small to have enough cross-cutting space, a 45° cross-cut grid would be taken. Nichiban tape (No. 405), Scotch tape (No. 610), or other tapes of the same type (18 mm broad, tape viscosity should be greater than or equal to 5.3 N/18 mm broadth) was applied over the sample surface and compacted with a rubber to allow the tape sufficiently in contact with the sample surface. The sample standed for 3 min. Tape was removed by pulling it off rapidly back over itself in an angle of 90°. The testing surface was visually examined and assessed with reference to ISO standard.

ISO Standard Rating

0 scale: 5B

Edges of incisions are completely smooth, and no peeling occurs at the edges of lattices.

1 scale: 4B

There is a small piece of peeling at the intersections of incisions, and actual failure is less than or equal to 5%.

2 scale: 3B

There is peeling at the edges or intersections of incisions, with a peeling area from 5% to 15%.

3 scale: 2B

There is partial peeling or a large piece of peeling along the edges of incisions, or part of lattices is wholly peeled off, with a peeling area in a range of 15%-35%.

4 scale: 1B

There is much peeling at the edges of incisions, or part or all of some lattices are peeled off, with a peeling area in a range of 35%-65%.

5 scale: 0B

The painting peels off significantly at the edges or intersections of incisions, with a peeling area greater than 65%.

The testing result is required at or above 4B.

3. Haze

X-rite: 7000A colorimeter was used to measure haze. Three testings were required on different positions of the sample and results were recorded.

4. Water Contact Angle

A commercial contact angle tester was used. An initial contact angle greater than 103 is required.

TABLE 2
Performance testing results

| | Example 1 | Example 2 | Example 3 |
|---|---|---|---|
| Hardness | 1 KG*4H | 1 KG*4H | 1 KG*4H |
| Haze | 30~35% | 20~25% | 10~15% |
| Adhesion | 4B | 4B | 4B |
| Water contact | 104.2 | 105.6 | 105.2 |
| angle | | | |

Although particular aspects of this invention have been explained and described above, it will be evident to those skilled in the art that numerous variations and modifications to the present invention may be made without departing from the scope and spirit of the present invention. Therefore, the appended claims are intended to encompass these variations and modifications falling within the present invention.

1. An UV curable coating composition, comprising an UV curable polyurethane acrylate oligomer having functionality greater than or equal to 6 and an active monomer.

2. The UV curable coating composition according to claim 1, wherein the UV curable polyurethane acrylate oligomer has a number average molecular weight from 700 to 2500.

3. The UV curable coating composition according to claim 1, wherein the active monomer comprises three or more functionality active monomers.

4. The UV curable coating composition according to claim 3, wherein the active monomer comprises pentaerythritol tetraacrylate, tetra(ethoxy) pentaerythritol tetraacrylate, and dipentaerythritol hexaacrylate.

5. The UV curable coating composition according to claim 1, wherein the polyurethane acrylate oligomer comprises 20-60 wt % based on the weight of the coating composition.

6. The UV curable coating composition according to claim 1, wherein the active monomer comprises 5-25 wt % based on the weight of the coating composition.

7. A method of forming a coating on a substrate, comprising applying an UV curable coating composition to at least a portion of the substrate, wherein the UV curable coating composition comprises an UV curable polyurethane acrylate oligomer having functionality greater than or equal to 6 and an active monomer.

8. A coated substrate, comprising a substrate and an UV curable coating composition deposited on at least a portion of the substrate, wherein the UV curable coating composition comprises an UV curable polyurethane acrylate oligomer having functionality greater than or equal to 6 and an active monomer.

9. The coated substrate according to claim 8, wherein the substrate comprises a substrate formed from the group consisting of polymethylmethacrylate, polycarbonate, and polyethylene terephthalate.

10. The coated substrate according to claim 8 or 9, wherein the substrate is a substrate useful for a display on board, a PET protective film and a display for computers and mobile phones.
